(19) United States
(12) Patent Application Publication
(10) Pub. No.: US 2015/0200556 A1
(43) Pub. Date: Jul. 16, 2015

(54) MOBILE DEVICE CHARGER

(71) Applicant: Jose Ramon Garcia, Dallas, TX (US)

(72) Inventor: Jose Ramon Garcia, Dallas, TX (US)

(21) Appl. No.: 14/597,049

(22) Filed: Jan. 14, 2015

Related U.S. Application Data
(60) Provisional application No. 61/927,403, filed on Jan. 14, 2014.

(51) Int. Cl. H02J 7/00

(52) U.S. Cl. CPC H02J 7/0044

(57) ABSTRACT

A device for injecting power into a mobile device during a single use. The device includes a power accumulator configured to store power which can be injected into a mobile device during a single-use. The device also includes a mobile device interface configured to form an electrical connection between the power accumulator and the mobile device. A boost circuit is configured to manage the injection of power into the mobile device through the electrical connection. The device includes a housing configured to contain the power accumulator and the boost circuit. The device also includes a recharging prevention mechanism configured to prevent a mobile device user of the mobile device from recharging the power accumulator.

### CROSS-REFERENCE TO RELATED APPLICATION

This application claims the benefit under 35 U.S.C. §119(e) of U.S. Provisional Application No. 61/927,403 filed Jan. 14, 2014, which is incorporated herein by reference.

### BACKGROUND

An area of ongoing research and development is development of mobile devices. As mobile devices have become more complex and become more capable of performing a variety of different functions, mobile devices have begun to consume power at faster rates. There therefore exists a need for devices and systems for charging mobile devices. In particular there exists a need for mobile systems and devices and systems that are capable of charging a mobile device anywhere.

Other limitations of the relevant art will become apparent to those of skill in the art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

A device for injecting power into a mobile device during a single use. In various implementations, the device includes a power accumulator configured to store power which can be injected into a mobile device during a single-use. In various implementations, the device also includes a mobile device interface configured to form an electrical connection between the power accumulator and the mobile device. Further, in various implementations, a boost circuit is configured to manage the injection of power into the mobile device through the electrical connection. In various implementations, the device includes a housing configured to contain the power accumulator and the boost circuit. Additionally, in various implementations, the device also includes a recharging prevention mechanism configured to prevent a mobile device user of the mobile device from recharging the power accumulator.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a network for providing single-use mobile device power injectors to mobile device users.

FIG. 2 depicts a diagram of an example of a single-use mobile device power injector.

FIG. 3 depicts a diagram of an example of a single-use mobile device power injector with safety features.

FIG. 4 depicts a flowchart of an example of a method for distributing single-use mobile device power injectors.

FIG. 5 depicts a flowchart of an example of a method for redistributing a used single-use mobile device power injector.

FIG. 6 depicts a flowchart of an example of a method for operating a single-use mobile device power injector.

### DETAILED DESCRIPTION

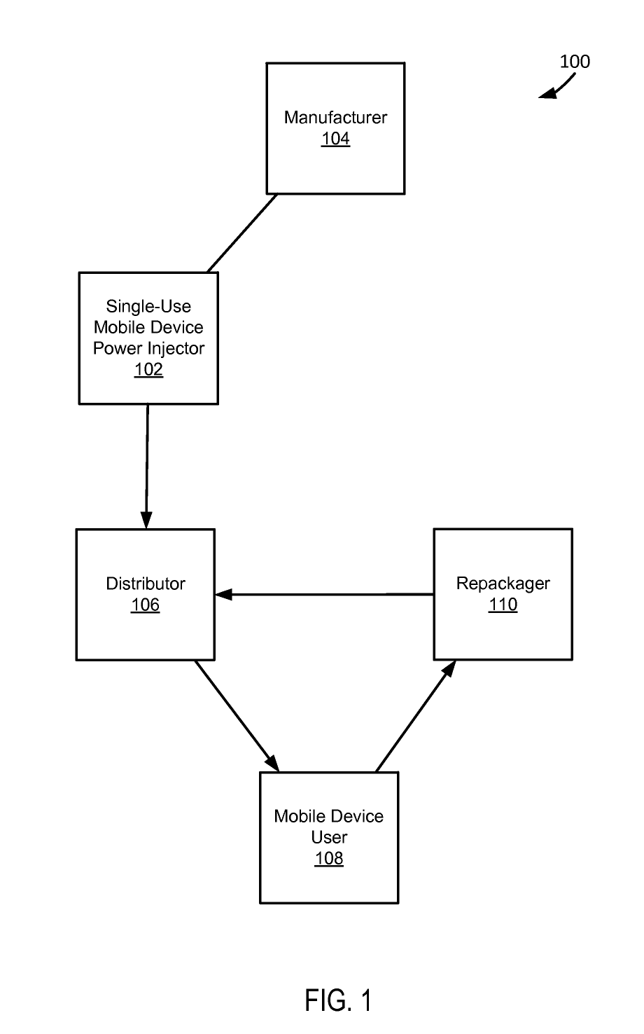

FIG. 1 depicts a diagram 100 of an example of a network for providing single-use mobile device power injectors to mobile device users. The example network shown in FIG. 1, include a manufacturer 104 of a single-use mobile device power injector 102, a distributor 106 of a single-use mobile device power injector 102, a mobile device user 108, and a repackager 110 of a single-use mobile device power injector 102.

The single-use mobile device power injector 102 functions to inject power into a mobile device. In injecting power into a mobile device, the single-use mobile device power injector 102 can store power that can be injected into a mobile device. In storing power that can be injected into a mobile device, the single-use mobile device power injector 102 can supply power to a mobile device, from a power accumulator, without being coupled to another power source, e.g. an outlet of a power grid. For example, the single-use mobile device power injector 102 can include a battery that converts stored chemical energy into electrical power into a mobile device. The single-use mobile device power injector 102 can be mobile. In being mobile, the single-use mobile device power injector 102 can be coupled to a mobile device and inject power into the mobile device as either or both the single-use mobile device power injector 102 and the mobile device are moved.

In a specific implementation, the single-use mobile device power injector 102 functions to provide power to a mobile device during a single-use of the single-use mobile device power injector 102. As used in this paper, single-use refers to using the single-use mobile device power injector 102 for as long as it can provide power. Further single-use refers to using the single-use mobile device power injector 102 as it is received from the distributor without a user recharging the single-use mobile device power injector 102. Depending upon implementation-specific or other considerations, a user can use the single-use mobile device power injector 102 for a portion of a length during which the single-use mobile device power injector 102 can provide power. For example, a user can utilize the single-use mobile device power injector 102 such that it injects 50% of the total power which it can provide.

In a specific implementation, the single-use mobile device power injector 102 includes one or a plurality of recharging prevention mechanisms to prevent a user from recharging the single-use mobile device power injector 102. A recharging prevention mechanism, included as part of the single-use mobile device power injector 102, prevents a user from recharging the single-use mobile device power injector 102, therefore ensuring that the single-use mobile device power injector 102 is single-use. Depending upon implementation-specific or other considerations, a recharging prevention mechanism can be part of either or both a mobile device interface through which the single-use mobile device power injector 102 is coupled to a mobile device and circuits of the recharging prevention mechanism. For example, a recharging prevention mechanism can include one or an applicable combination of a magnetic switch, an identification resistor, a custom power connector, an integrated circuit or EPROM chip configured to recognize a specific recharging station, a chip programmed or containing an optical identifier, and/or a coded charger. Further depending upon implementation-specific or other considerations, a recharging prevention mechanism can be part of a charging point of a recharging station.

In a specific implementation, the single-use mobile device power injector 102 includes a variable attachment mechanism. A variable attachment mechanism functions to attach the single-use mobile device power injector 102 to a mobile device. Examples of a variable attachment mechanism include tape, glue, residue free contact, Velcro®, mechanical means, clips, and applicable means for attaching two objects together. Depending upon implementation-specific or other considerations, a variable attachment mechanism can couple the single-use mobile device power injector 102 to a case coupled to a mobile device, thereby coupling the single-use mobile device power injector 102 to the mobile device. In coupling the single-use mobile device power injector 102 to a case coupled to a mobile device, the single-use mobile device power injector 102 can inject power into the mobile device without having to remove the case from the mobile device. A variable attachment mechanism is variable in that it can be used to attach the single-use mobile device power injector 102 to multiple types of mobile devices and multiple types of mobile device cases. For example, a variable attachment mechanism can be used to attach the single-use mobile device power injector 102 to an iPhone® or an iPad®. Depending upon implementation-specific or other considerations, a variable attachment mechanism can be used to attach the single-use mobile device power injector 102 to a mobile device in a manner that does not interfere with the functionalities of the mobile device. For example, if the mobile device is a smart phone, a variable attachment mechanism can be used to attach the single-use mobile device power injector 102 without blocking a camera of the smart phone.

In a specific implementation, the single-use mobile device power injector 102 is of a size to allow the single-use mobile device power injector 102 to be mobile with a mobile device to which the single-use mobile device power injector 102 is coupled. For example, the single-use mobile device power injector 102 can include a housing that is one inch long, by one inch thick, by one quarter inch thick. Depending upon implementation-specific or other considerations, the single-use mobile device power injector 102 can be sized according to a type of mobile device for which the single-use mobile device power injector 102 is configured to inject power. For example the single-use mobile device power injector 102 can be smaller sized if it is configured for an iPhone® as opposed to of it is configured to an iPad®.

The manufacturer 104 functions to manufacture the single-use mobile device power injector 102. Depending upon implementation-specific or other considerations, the manufacturer 104 can charge the single-use mobile device power injector 102 either after or during the manufacturing process. For example, the manufacturer 104 can ship manufactured single-use mobile device power injectors that are pre-charged. Depending upon implementation-specific or other considerations, the manufacturer can be implemented at one or a plurality of facilities throughout the world.

In a specific implementation, the manufacturer 104 functions to manufacture single-use mobile device power injectors for multiple types of mobile devices. Depending upon implementation-specific or other considerations, the manufacturer 104 can manufacture a single-use mobile device power injector specific to a mobile device type, e.g. based on a manufacturer of a mobile device and/or a version of the mobile device. For example, the manufacturer 104 can manufacture a single-use mobile device power injector with a mobile device interface for iPhones®. Further depending upon implementation-specific or other considerations, the manufacturer 104 can manufacture a single-use mobile device power injector compatible with a plurality of mobile devices. For example, the manufacturer 104 can manufacture a single-use mobile device power injector that includes or is compatible with a plurality of mobile device interfaces for iPhones® and Samsung® phones.

In a specific implementation, the manufacturer 104 functions to manufacture single-use mobile device power injectors with varying power storage capacities. For example, the manufacturer 104 can manufacture single-use mobile device power injectors with 1100 milliampere-hours of storage capacity, 2200 milliampere-hours of storage capacity, and 3200 milliampere-hours of storage capacity. In manufacturing single-use mobile device power injectors with varying power storage capacities, the manufacturer 104 can manufacture single-use mobile device power injectors with batteries of varying power storage capacities, and/or single-use mobile device power injectors with varying numbers of batteries.

The distributor 106 functions to distribute single-use mobile device power injectors. The distributor 105 can distribute single-use mobile device power injectors received from the manufacturer 104 or an intermediary of the manufacturer 104. Depending upon implementation-specific or other considerations, an intermediary of the manufacturer 104 can functions to charge single-use mobile device power injectors if not pre-charged by the manufacturer. The distributor 106 can function to distribute a plurality of different types of single-use mobile device power injectors. The distributor 106 can distribute single-use mobile device power injectors of with various power storage capacities, and/or single-use mobile device power injectors for different mobile device types. For example, the distributor 106 can distribute single-use mobile device power injectors with different power storage capacities.

In a specific implementation, the distributor 106 is a store distributing other items separate from a single-use mobile device power injector. For example the distributor 106 can be a convenience store or a grocery store. In a specific implementation, the distributor 106 is a device that does not require a human clerk. For example, the distributor 106 can be a vending machine at an airport.

In a specific implementation, the distributor 106 functions to facilitate payment by mobile device users for distributed single-use mobile device power injectors. In facilitating payment, the distributor 106 can refrain from distributing a single-use mobile device power injector until payment is received from a mobile device user. Depending upon implementation-specific or other considerations, the distributor 106 can include a clerk responsible for accepting payment or an automated system that can accept payment. The distributor 106 can charge a different price for different types of single-use mobile device power injectors. For example, the distributor 106 can charge different prices for single-use mobile device power injectors based on power storage capacities for the single-use mobile device power injectors. The distributor 106 can charge a mobile device user based on a refund for returning a used single-use mobile device power injector. For example, the distributor 106 can charge a mobile device user four dollars less for a single-use mobile device power injector if the user has a refund for returning a single-use mobile device power injector.

In a specific implementation, the distributor 106 functions to accept returned and used single-use mobile device power injectors. A returned and used single-use mobile device power injector can have all or a portion of stored power injected from it. Depending upon implementation-specific or other considerations, the distributor 106 can give a refund to a mobile device user for a returned used single-use mobile device power injector. For example, if a mobile device user 106 returns a used single-use mobile device power injector, then the distributor 106 can give a four dollar refund to the mobile device user.

The mobile device user 106 is a person who utilizes the single-use mobile device power injector 102 to inject power into a mobile device of the mobile device user 106. A mobile device of the mobile device user 106 can include an applicable electronic device that is mobile. For example, a mobile device can include a phone, a smartphone, a tablet, and a laptop. In utilizing the single-use mobile device power injector 102 to inject power into a mobile device, the mobile device user 106 can attach the single-use mobile device power injector 102 to the mobile device using an attachment mechanism. Further in utilizing the single-use mobile device power injector 102 to inject power into a mobile device, the mobile device user 106 can directly connect a mobile device interface of the single-use mobile device power injector 102 to an input and/or output port of the mobile device. Power can be injected from the single-use mobile device power injector 102 into the mobile device through a connection formed using an input and/or output port of the mobile device and a mobile device interface of the single-use mobile device power injector 102.

In a specific implementation, the mobile device user 108 can return a previously used single-use mobile device power injector. Depending upon implementation-specific or other considerations, the mobile device user 106 can return a previously used single-use mobile device power injector to a distributor or a drop-off location, Further depending upon implementation-specific or other considerations, the mobile device user 106 can return a previously used single-use mobile device power injector through a courier service, e.g. the mail system, to a repackager. After returning a previously used single-use mobile device power injector, a mobile device user 106 can receive a refund or a benefit that provides an incentive for the mobile device user 106 to return the previously used single-use mobile device power injector. For example, the mobile device user 106 can receive a gift card or a refund for a next purchase of a single-use mobile device power injector by returning a previously used single-use mobile device power injector.

The repackager 110 functions to receive previously used single-use mobile device power injectors and refurbish them to allow them to inject power into mobile devices. In refurbishing used single-use mobile device power injectors, the repackager 110 can recharge a power accumulator, e.g. a battery, included as part of the used single-use mobile device power injectors. The repackager 110 can include or possess corresponding charging mechanisms to recharging prevention mechanisms to allow the repackager 110 to recharge a single-use mobile device power injector 102 that included recharging prevention mechanisms. For example, the repackager 110 can possess a corresponding custom charging point which allows the repackager to recharge a used single-use mobile device power injector 102. In another example, the repackager 110 possess a resistor rating of an identification resistor included in a corresponding used single-use mobile device power injector, to allow the single-use mobile device power injector to be recharged by the repackager 110. Further, in refurbishing used single-use mobile device power injectors, the repackager 110 can inspect components of a used single-use mobile device power injector and fix or replace failed components. For example, if a housing of a used single-use mobile device power injector is cracked, then the repackager 110 can replace the housing.

In a specific implementation, the repackager 110 functions to facilitate transport of refurbished single-use mobile device power injectors to the distributor 106. In facilitating transport of refurbished used single-use mobile device power injectors to the distributor 106, the refurbished single-use mobile device power injectors can be utilized mobile device users again to inject power into mobile devices. Depending upon implementation-specific or other considerations the repackager 110 is the same entity as the distributor 106. For example, the repackager 110 can be a store that distributes single-use mobile device power injectors, both refurbished and new. The repackager 110 can use an applicable means for facilitating transport of refurbished single-use mobile device power injectors to the distributor 106, such as a courier service.

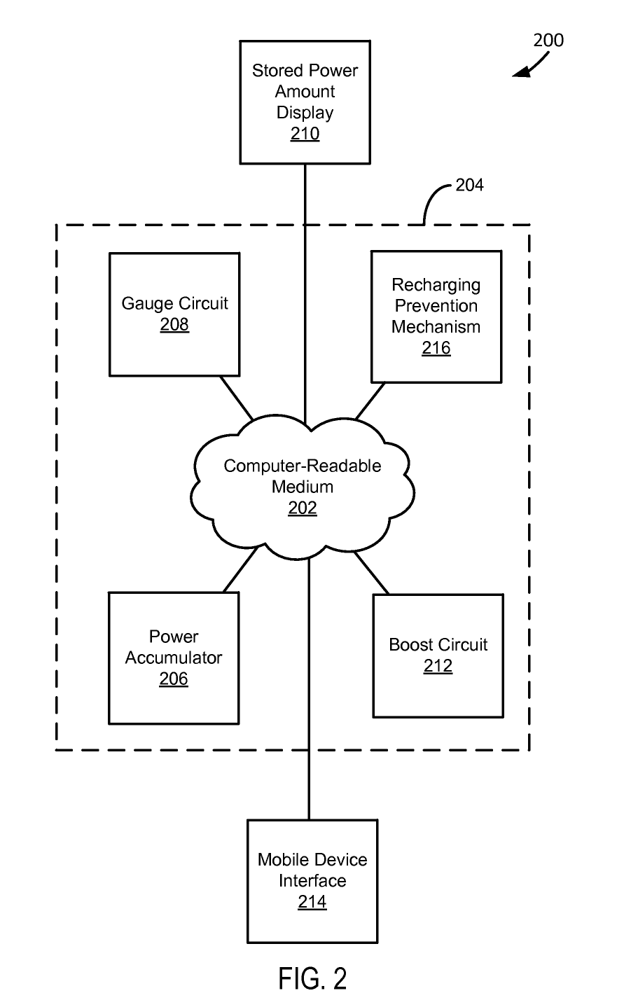

FIG. 2 depicts a diagram 200 of an example of a single-use mobile device power injector. The injector of the example of FIG. 2 includes a computer-readable medium 202, a housing 204, a power accumulator 206, a gauge circuit 208, a stored power amount display 210, a boost circuit 212, a mobile device interface 214, and a recharging prevention mechanism 216.

The power accumulator 206, the gauge circuit 208, the stored power amount display 210, the boost circuit 212, the mobile device power interface 214, and the recharging prevention mechanism 216 are coupled to each other through the computer-readable medium 202. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. All or portions of the computer-readable medium 202, the power accumulator 206, the gauge circuit 208, the stored power amount display 210, the boost circuit 212, the mobile device power interface 214, and the recharging prevention mechanism 216 can be implemented as part of a printed circuit board.

The computer-readable medium 202 is intended to represent a variety of potentially applicable technologies. For example, the computer-readable medium 202 can be used to form a network or part of a network. Where two components are co-located on a device, the computer-readable medium 102 can include a bus or other data conduit or plane.

The computer-readable medium 202, and any other applicable systems or devices described in this paper can be implemented as a computer system or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a special-purpose central processing unit (CPU) configured to carry out specific functions, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

A computer system can be implemented as an engine, as part of an engine or through multiple engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor transforms data into new data using implemented data structures and methods, such as is described with reference to the FIGS. in this paper.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In a specific implementation, the housing 204 functions to contain the internal circuits and systems of the single-use mobile device power injector. The housing 204 can provide protection to the internal circuits and systems of the single-use mobile power injector. In providing protection, the housing 204 can provide protection from forces applied to the single-use mobile device power injector and an environment surrounding the single-use mobile device power injector. For example, the housing 204 can be waterproof to protect the internal circuits and system of the single-use mobile device power injector from liquid in the environment. Depending upon implementation-specific or other considerations, the housing 204 can be constructed from, at least in part, a polymer material.

In a specific implementation, the power accumulator 206 functions to store power which can be injected into a mobile device. The power accumulator 206 can include batteries, capacitors, nano technology batteries, and/or paper batteries. For example, a power accumulator can be a lithium ion battery. Depending upon implementation-specific or other considerations, the power accumulator 206 can include a combination of a plurality of batteries. For example, the power accumulator 206 can include two batteries. The power accumulator 206 can be of a size to allow the single-use mobile device power injector to be portable with a mobile device to which it is coupled.

In a specific implementation, the power accumulator 206 includes one or a plurality of capacitors. For example, the power accumulator 206 can include one or a plurality of super capacitors. In including a super capacitor, the power accumulator 206 can store power by storing a static charge as opposed to generating power through an electrochemical reaction. A super capacitor can include electrostatic double-layer capacitance and/or pseudocapacitance to store change. Depending upon implementation-specific or other considerations, a super capacitor included as part of the power accumulator 206 can be comprised of carbon electrodes, metal oxide electrodes, and/or polymer electrodes. A super capacitor included as part of the accumulator 206 can include an electrolyte that forms a conductive connection between two electrodes. Further depending upon implementation-specific or other considerations, a super capacitor included as part of the accumulator 206 can be polarized through the use of asymmetric electrodes.

In a specific implementation, the gauge circuit 208 functions to determine an amount of power that is stored in the power accumulator 208. The gauge circuit 208 can constantly determine an amount of power stored in the power accumulator 208 constantly throughout the life of and/or during operation of the single-use mobile device power injector. The gauge circuit 208 includes applicable components for determining an amount of power stored in the power accumulator 206. For example, the gauge circuit 208 can use one or a plurality of resistors and switches to determine an amount of power stored in the power accumulator. The gauge circuit can generate an amount of power signal which indicates an amount of power stored in the power accumulator 206.

In a specific implementation, the stored power amount display 210 functions to provide an indication of an amount of power stored in the power accumulator 206. The stored power amount display 210 can include a visual display that indicates an amount of power stored in the power accumulator 206. For example, the stored power amount display 210 can include one or a plurality of light emitting diodes which can be illuminated to indicate an amount of power stored in the power accumulator 206. The stored power amount display 210 can provide an indication of an amount of power stored in the power accumulator 206 based on an amount of power signal generated by the gauge circuit 208. Depending upon implementation-specific or other considerations, parts of the power amount display 210 can be implemented within a printed circuit board supporting the internal circuits of the single-use mobile device charge injector. Further depending upon implementation-specific or other considerations, parts of the power amount display 210 can be implemented as part of the housing 204, thereby allowing a mobile device user to view the stored power amount display 210.

In a specific implementation, the boost circuit 212 functions to regulate the injection of power from the power accumulator 206 into a mobile device. The boost circuit 212 can be coupled to a switch which a mobile device user can activate to cause the boost circuit 212 to begin or stop injection of power from the power accumulator 206 into a mobile device. For example, a user can activate a switch to cause the boost circuit 212 to begin injecting power form the power accumulator 206 into a mobile device. In regulating the injection of power form the power accumulator 206 into a mobile device, the boost circuit 212 can increase a voltage of power transferred out of the power accumulator 206. For example, the boost circuit 212 can increase the voltage of power from 3.7 V to 5 V. The boost circuit 212 can function to transmit power from the power accumulator 206 into a mobile device through a connection formed between the mobile device and the single-use mobile device power injector.

In a specific implementation, the mobile device interface 214 functions to form a connection between a mobile device and the single-use mobile device power injector. The mobile device interface 214 can be implemented as part of an electrically conductive cord which extends out of the housing 204 of the single-use mobile device power injector. Through a connection formed using the mobile device interface 214, the boost circuit can regulate the injection of power into a mobile device. In operation, the mobile device interface 214 is configured to be coupled to an input and or output port of a mobile device. Depending upon implementation-specific or other considerations, the mobile device interface 214 is specific to a mobile device type. For example, the mobile device interface can include a Lightning® connector. Further depending upon implementation-specific or other considerations, the mobile device interface 214 can include a universal adapter which can be coupled to a plurality of different connectors specific to mobile device types. For example, the mobile device interface can include a universal adapter configured to be coupled to a Lightning® connector. Different connectors specific to mobile device types can be sold separately or along with the single-use mobile device power injector.

In a specific implementation, the recharging prevention mechanism 216 functions to inhibit a mobile device user from recharging the single-use mobile device power injector. Specifically, the recharging prevention mechanism 216 functions to prevent a mobile device user from recharging the power accumulator 206. Depending upon implementation-specific or other considerations, the recharging prevention mechanism 216 can be implemented in part in the single-use mobile device power injector and/or at a recharging station of a repackager. For example, the recharging prevention mechanism 216 can be implemented as part of the power accumulator 206. The recharging prevention mechanism 216 can be implemented as one or an applicable combination of a magnetic switch, a custom power connector, an integrated circuit or EPROM chip configured to recognize a specific recharging station, a chip programmed or containing an optical identifier, and/or a coded charger. Further depending upon implementation-specific or other considerations, the recharging prevention mechanism 216 can be a mechanism that prevents recharging and/or power injection into a mobile device if the housing 204 is tampered with or broken. For example, the recharging prevention mechanism 216 can include a mechanism that causes the boost circuit 212 to stop the transfer of power from the power accumulator 206 to a mobile device if the housing is broken.

In a specific implementation, the recharging prevention mechanism 216 includes an identification resistor. An identification resistor can be integrated into a printed circuit board and have a unique resistor rating associated with it. In preventing recharging of the power accumulator 206, an identification resistor can prevent recharging unless the correct resistor rating is used in recharging the power accumulator 206. In various implementations, a resistor rating of an identification resistor can be kept secret from mobile device users and only be known by repackagers of single-use mobile device power injectors. As a result, only repackagers can recharge the single-use mobile device power injector, while mobile device users are prevented from recharging the single-use mobile device power injector.

In an example of operation of the example injector shown in FIG. 2, the power accumulator 206 stores power which can be injected into a mobile device. Further, in the example of operation of the example injector shown in FIG. 2, the gauge circuit determines an amount of power stored in the power accumulator 206 and generates an amount of power signal which indicates an amount of power stored in the power accumulator 206. In the example of operation of the example injector shown in FIG. 2, the stored power amount display 210 displays an amount of power stored in the power accumulator 206 using the amount of power signal generated by the gauge circuit. Additionally, in the example of operation of the example injector shown in FIG. 2, the boost circuit regulates injection of power from the power accumulator to a mobile device through a connection formed using the mobile device interface 214. In the example of operation of the example injector shown in FIG. 2, the recharging prevention mechanism 216 prevents a mobile device user from recharging the power accumulator 206.

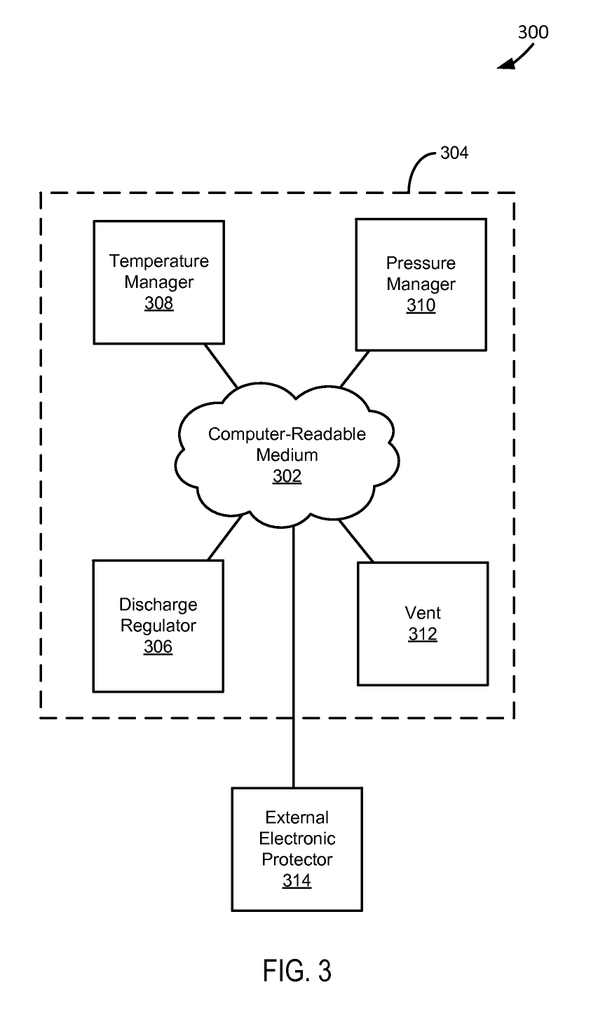

FIG. 3 depicts a diagram 300 of an example of a single-use mobile device power injector with safety features. The example system injector in FIG. 3 includes a computer-readable medium 302, a housing 304, a discharge regulator 306, a temperature manager 308, a pressure manager 310, a vent 312, and an external electronic protector 314. In the example injector shown in FIG. 3 are coupled to each other through the computer-readable medium 302.

In a specific implementation, the housing 304 functions to contain the internal components of the single-use mobile device power injector. The housing 304 can function to protect the internal components of the single-use mobile device power injector from forces applied to the single-use mobile device power injector and atmospheric conditions surrounding the single-use mobile device power injector.

In a specific implementation, the discharge regulator 306 functions to manage discharging of a power accumulator of the single-use mobile device power injector in injecting power into a mobile device. In managing discharge of a power accumulator, the discharge regulator 306 can monitor the rate at which a power accumulator is discharged. Further, in managing discharge of a power accumulator, the discharge regulation 306 can cause a power accumulator to stop discharging. For example, the discharge regulator 306 can cause a control circuit coupled to a power accumulator to cut off current through the power accumulator.

In a specific implementation, the temperature manager 308 functions to manage temperature within the housing 304 of the single-use mobile device power injector. The temperature manager 308 can include a temperature sensor for determining a temperature within the housing 304 of the single-use mobile device power injector. In managing temperature within the housing 304, the temperature manager 308 can cause a temperature switch to activate to limit high current surges, thereby lowering the temperature within the housing 304. Further, in managing temperature within the housing 304, the temperature manager 308 can cause a fuse to be activated, and subsequently terminating current within the single-use mobile device power injector, if the temperature within the housing exceeds a threshold temperature. For example, the temperature manager 308 can be configured to cause a fuse to be activated if the temperature in the housing exceeds 90° C.

In a specific implementation, the pressure manager 310 functions to manage pressure within the housing 304. The pressure manager can include a pressure sensor for determining a pressure within the housing 304. The pressure manager 310 can cause a switch to activate, thereby breaking current within the single-use mobile device power injector, if the pressure within the housing 304 exceeds a threshold pressure. For example, the pressure manager 310 can be configured to cause a switch to activate if pressure within the housing 304 exceeds 1000 kPa.

In a specific implementation, the vent 312 functions to open and release gas from within the housing 304. The vent 312 can be integrated as part of the housing 304 and provide a physical passageway through the housing 304. The vent 312 can operate in conjunction with the pressure manager 310. For example, the pressure manager 310 can cause the vent to open if a threshold pressure level is exceeded within the housing 304 and/or if a threshold pressure change rate occurs within the housing 304.

In a specific implementation, the external electronic protector 314 functions to manage a charge of a power accumulator included as part of the single-use mobile device power injector. The external electronic protector 314 can include a charge regulator that prevents a charge of a power accumulator from exceeding a threshold charge level. For example, the electronic protector 314 can prevent a change of a power accumulator in the single-use mobile device power injector from exceeding 4.3 V.

In an example of operation of the example injector shown in FIG. 3, the discharge regulator manages discharging of a power accumulator of the single-use mobile device power injector. Further, in the example of operation of the example injector shown in FIG. 3, the temperature manager 308 manages temperature levels within the housing 304 of the single-use mobile device power injector. In the example of operation of the example injector shown in FIG. 3, the pressure manager 310 manages pressure levels within the housing 304 using the vent 312. Additionally, in the example of operation of the example injector shown in FIG. 3, the external electronic protector manages charge of the power accumulator of the single-use mobile device power injector.

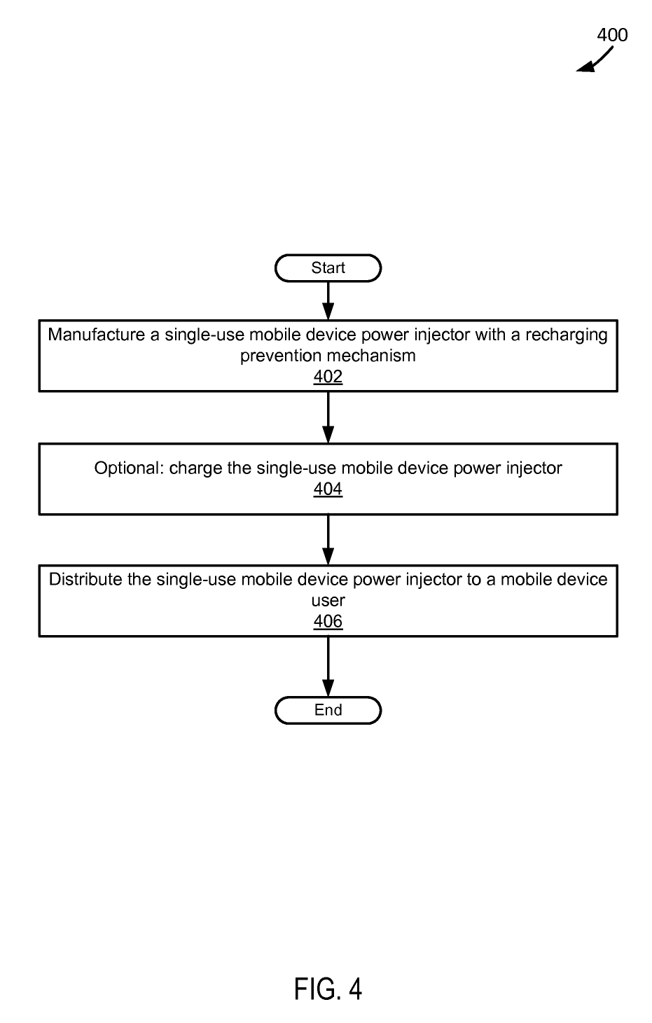

FIG. 4 depicts a flowchart 400 of an example of a method for distributing single-use mobile device power injectors. The flowchart 400 begins at module 402, where a single-use mobile device power injector is manufactured. A single-use mobile device power injector, manufactured at module 402, includes a recharging prevention mechanism to prevent a mobile device user from recharging the single-use mobile device power injector. The single-use mobile device power injector can be charged during or after the manufacturing process.

The flowchart 400 continues to module 404, where optionally, the single-use mobile device power injector is optionally charged. Module 404 is optional in that, if the single-use mobile device power injector is pre-charged by the manufacture, then it does not need to be charged. Depending upon implementation-specific or other considerations, an intermediary or a distributor can charge the single-use mobile device power injector. An entity responsible for charging the single-use mobile device power injector can have an applicable means or mechanism of charging the single-use mobile device power injector in spite of the recharging prevention mechanism. For example, if the recharging prevention mechanism includes an identification resistor, then an entity responsible for charging the single-use mobile device power injector can possess a resistor value of the identification resistor, thereby allowing the entity to charge the single-use mobile device power injector. A resistor value can include a resistance of the identification resistor.

The flowchart 400 continues to module 406, where the single-use mobile device power injector is distributed to a mobile device user by a distributor. Depending upon implementation-specific or other considerations, a distributor can be a store operated by a human or an automated vending machine. A distributor can accept payment for the single-use mobile device power injector. Further depending upon implementation-specific or other considerations, in distributing a single-use mobile device power injector a rebate or reward can be given to a mobile device user if they return a previously used single-use mobile device power injector.

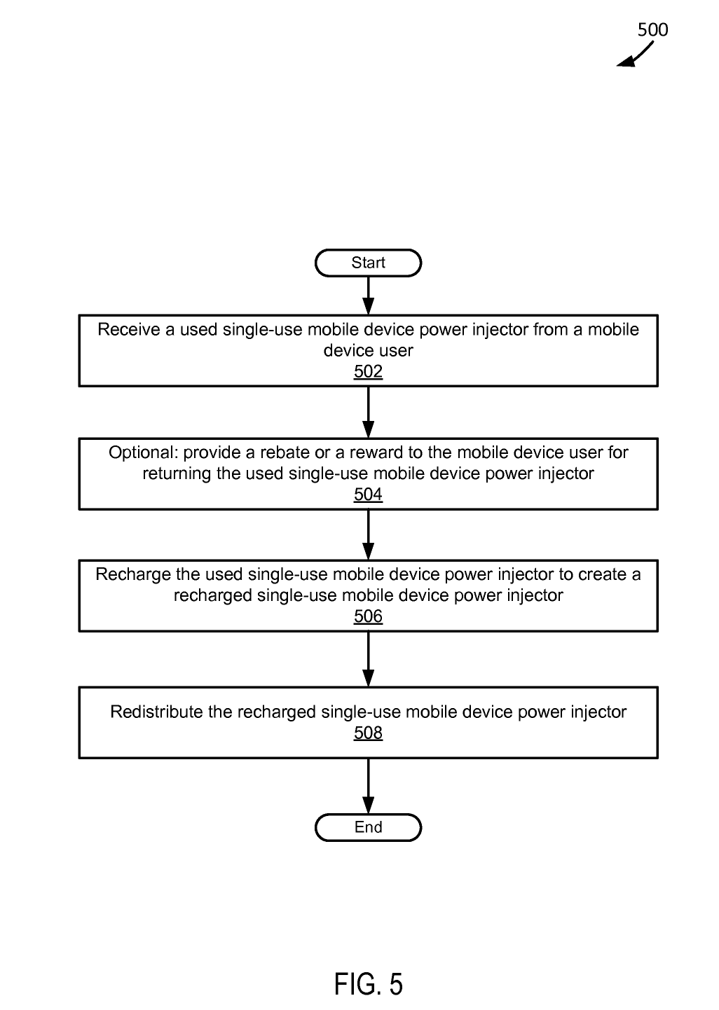

FIG. 5 depicts a flowchart 500 of an example of a method for redistributing a used single-use mobile device power injector. The flowchart 500 begins at module 502, where a used single-use mobile device power injector is received from a mobile device user. A used single-use mobile device power injector can be received from a mobile device user through a distributor or through a drop off station.

The flowchart 500 continues to module 504 where a rebate or a reward can be given to a mobile device user who returns a used single-use mobile device power injector. A rebate can include a return of money that can be used to purchase a single-use mobile device power injector. A reward can include money or a gift certificate. In providing a rebate or a reward, a mobile device user is incentivized to return used single-use mobile device power injectors.

The flowchart 500 continues to module 506, where the used single-use mobile device power injector is recharged to create a recharged single-use mobile device power injector. An entity responsible for charging the used single-use mobile device power injector can have an applicable means or mechanism of recharging the single-use mobile device power injector in spite of a recharging prevention mechanism. For example, if a recharging prevention mechanism includes an identification resistor, then an entity responsible for charging the used single-use mobile device power injector can possess a resistor value of the identification resistor, thereby allowing the entity to charge the used single-use mobile device power injector.

The flowchart 500 continues to module 508, where the recharged single-use mobile device power injector is redistributed to a mobile device user. The recharged single-use mobile device power injector can be redistributed to a mobile device user through a distributor that can be a store operated by a human or an automated vending machine. In recharging and redistributing the used single-use mobile device power injector, the used single-use mobile device power injector is recycled.

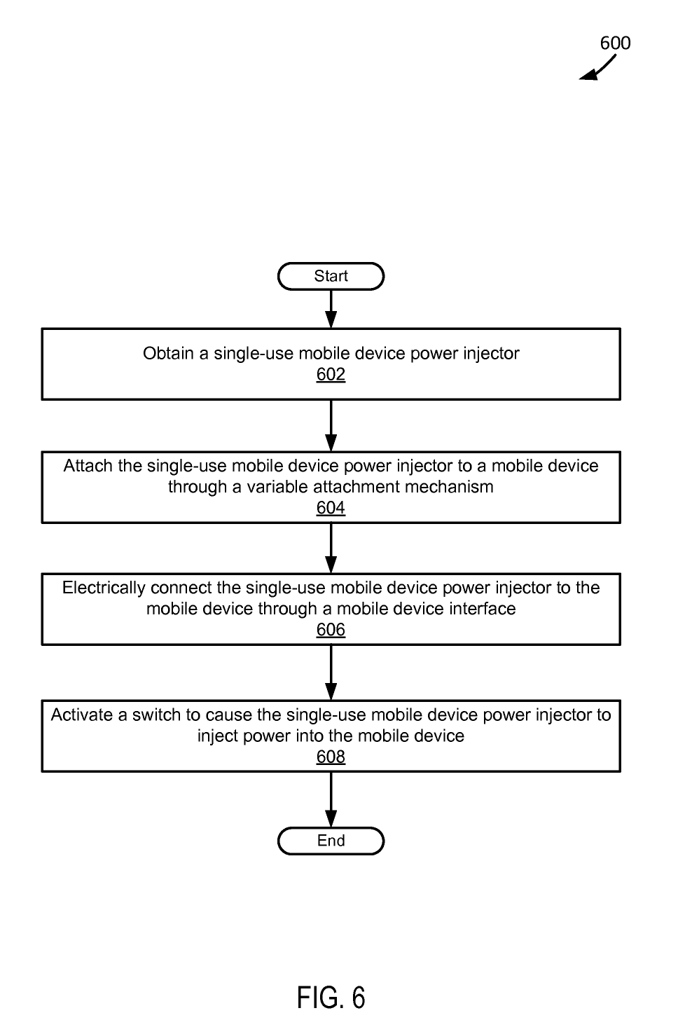

FIG. 6 depicts a flowchart 600 of an example of a method for operating a single-use mobile device power injector. The flowchart 600 begins at module 602, where a single-use mobile device power injector is obtained by a mobile device user. A single-use mobile device power injector can be obtained by a mobile device user from a distributor using, at least in part, a rebate.

The flowchart 600 continues to module 604, where the single-use mobile device power injector is attached to a mobile device through a variable attachment mechanism. A variable attachment mechanism can allow the single-use mobile device power injector to be attached to mobile devise of varying mobile device type. In attaching the mobile device to the single-use mobile device power injector, the attachment mechanism can attach the single-use mobile device power injector to a case of the mobile devise. Depending upon implementation-specific or other considerations, a variable attachment mechanism includes residue free contact.

The flowchart 600 continues to module 606, where the single-use mobile device power injector is electrically connected to the mobile device through a mobile device interface. Depending upon implementation-specific or other considerations, a mobile device interface can be specific to the mobile device, or a universal adapter that can be coupled to a connector specific to the mobile device.

The flowchart 600 continues to module 608, where a switch is activated to cause the single-use mobile device power injector to inject power into the mobile device. A switch can be activated by the mobile device user. Activating a switch can cause a boost circuit to increase the voltage of power provided by a power accumulator and subsequently injected into the mobile device through the connection formed using the mobile device interface.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A device comprising:
a power accumulator configured to store power which can be injected into a mobile device during a single-use;
a mobile device interface configured to form an electrical connection between the power accumulator and the mobile device;
a boost circuit configured to manage the injection of power into the mobile device through the electrical connection;
a housing configured to contain the power accumulator and the boost circuit;
a recharging prevention mechanism configured to prevent a mobile device user of the mobile device from recharging the power accumulator.

2. The device of claim 1, further comprising:
a gauge circuit configured to determine an amount of power stored in the power accumulator;
a stored power amount display configured to display an indication of the amount of power stored in the power accumulator.

3. The device of claim 1, wherein the recharging prevention mechanism includes a magnetic switch that is activated in order to recharge the power accumulator.

4. The device of claim 1, wherein the recharging prevention mechanism includes an identification resistor with a resistor value, the resistor value needed in order to recharge the power accumulator.

5. The device of claim 1, wherein the mobile device user lacks knowledge of the resistor value and a repackager has knowledge of the resistor value.

6. The device of claim 1, wherein the recharging prevention mechanism includes a customized charging point for operation with a unique charging station.

7. The device of claim 1, further comprising a variable attachment means configured to attach the housing to mobile devices of different mobile device types.

8. The device of claim 7, wherein the variable attachment means is configured to attach the housing to cases of the mobile devices, thereby removing the need to remove the cases from the mobile devices to attach the housing the mobile devices.

9. The device of claim 1, wherein the power accumulator was recharged by a repackager after being previously used during another single-use.

10. The device of claim 1, further comprising a discharge regulator configured to manage the discharge of power from the power accumulator during the injection of power into the mobile device.

11. The device of claim 1, further comprising a temperature manager configured to activate a fuse cutting off current from the power accumulator if a temperature within the housing exceeds a threshold temperature.

12. The device of claim 1, further comprising a pressure manager configured to activate a vent in the housing if a pressure within the housing exceeds a threshold pressure.

13. The device of claim 1, further comprising a pressure manager configured to activate a fuse cutting off current from the power accumulator if a pressure within the housing exceeds a threshold pressure.

14. The device of claim 1, further comprising an external electronic protector configured to manage a charge voltage of the power accumulator during recharging of the power accumulator.

15. The device of claim 1, wherein the power accumulator is a lithium ion battery.

16. A method comprising:
manufacturing a single-use mobile device power injector with a recharging prevention mechanism;
distributing the single-use mobile device power injector to a mobile device user, the mobile device user using the single-use mobile device power injector to create a used single-use mobile device power injector;
receiving the used single-use mobile device power injector from the mobile device user;
recharging the used single-use mobile device power injector to create a recharged single-use mobile device power injector;
redistributing the recharged single-use mobile device power injector.

17. The method of claim 16, wherein the recharging prevention mechanism is an identification resistor with a resistor value, the resistor value used in the recharging of the used single-use mobile device power injector.

18. The method of claim 16, further comprising providing a rebate to the mobile device user for returning the used single-use mobile device power injector.

19. The method of claim 16, further comprising:
determining if the single-use mobile device power injector was charged during manufacturing;
if it is determined that the single-use mobile device power injector was not charged fully during manufacturing, charging the single-use mobile device power injector fully before distributing the single-use mobile device power injector.

20. The method of claim 16, wherein the used single-use mobile device power injector is received at a drop off station.
